(19) United States
(12) Patent Application Publication
(10) Pub. No.: US 2022/0080991 A1
(43) Pub. Date: Mar. 17, 2022

(54) SYSTEM AND METHOD FOR REDUCING UNCERTAINTY IN ESTIMATING AUTONOMOUS VEHICLE DYNAMICS

(71) Applicants: Beijing Wodong Tianjun Information Technology Co., Ltd., Beijing (CN); JD.com American Technologies Corporation, Mountain View, CA (US)

(72) Inventors: Haiming Wang, Mountain View, CA (US); Liangliang Zhang, Mountain View, CA (US); Qi Kong, Mountain View, CA (US)

(21) Appl. No.: 17/017,877

(22) Filed: Sep. 11, 2020

(51) Int. Cl. B60W 50/04; B60W 50/02; B60W 50/00

(52) U.S. Cl. CPC B60W 50/04; B60W 50/0205; B60W 2520/125; B60W 2520/16; B60W 2520/14; B60W 2050/0031

(57) ABSTRACT

A system and a method for controlling an autonomous driving vehicle. The system includes vehicle sensors and a controller. The controller has a processor and a storage device storing computer executable code. The computer executable code, when executed at the processor, is configured to: receive vehicle parameters from the vehicle sensors; obtain a vehicle dynamic model by adding a dynamics error bound to a state space model, wherein the dynamics error bound is estimated using linear least square; minimize a linear quadratic regulator cost function based on the vehicle dynamic model; and control the vehicle using control input obtained from the minimized cost function.

### CROSS-REFERENCES

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates generally to the field of autonomous driving, and more particularly to systems and methods for accurately estimating state of an autonomous vehicle in optimal controlling of the vehicle.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Autonomous driving develops very fast in the recent years, and optimal control of autonomous driving requires accurate estimation of dynamics of an vehicle. However, the dynamics of the vehicle is complicated and it is hard to identify it if external disturbance and noise exist, for example when the dynamics has round to round and car to car variations. In most state of art, authors either assume that dynamic modelling is in priori and accurate, or use very complicated methods to estimate the dynamics which are very time consuming. Neither method is feasible in practice.

Therefore, an unaddressed need exists in the art to address the aforementioned deficiencies and inadequacies.

### SUMMARY

In certain aspects, the present disclosure relates to a system for controlling an autonomous vehicle. In certain embodiments, the system includes vehicle sensors and a controller installed on the autonomous vehicle. The controller has a processor and a storage device storing computer executable code. The computer executable code, when executed at the processor, is configured to: receive state parameters of the autonomous vehicle from the vehicle sensors; quantify a dynamics error bound based on the state parameters using linear least square; determine a state space model of the autonomous vehicle by incorporating the dynamics error bound in the state space model; minimize cost function of a linear quadratic regulator based on the state space model to obtain control input; and control the autonomous vehicle using the obtained control input.

In certain embodiments, the state space model is defined by xₜ₊₁=Axₜ+Buₜ+ωₜ. xₜ₊₁ is state of the autonomous driving vehicle at time t+1, xₜ is state of the autonomous driving vehicle at time t, uₜ is the control input of the autonomous driving vehicle at time t, and A and B are matrices of the state space model. Let xₜ₊₁=Θzₜ+ωₜ, Θ=[A B],

$${z}_{t} = [ \begin{matrix}{x}_{t} \\ {u}_{t}\end{matrix} ] ,$$

and for n sampling data, the disclosure has X=ΘZ+W,

$$X = [ \begin{matrix}{x}_{1} \\ {x}_{2} \\ ⋮ \\ {x}_{t + 1} \\ ⋮ \\ {x}_{n}\end{matrix} ] , Z = [ \begin{matrix}{z}_{0} \\ {z}_{1} \\ ⋮ \\ {z}_{t} \\ ⋮ \\ {z}_{n - 1}\end{matrix} ] , W = [ \begin{matrix}{ω}_{0} \\ {ω}_{1} \\ ⋮ \\ {ω}_{t} \\ ⋮ \\ {ω}_{n - 1}\end{matrix} ] .$$

The dynamics error bound is calculated by E=(Z^{T} Z)⁻¹ZW, and the state space model is obtained by adding the dynamics error bound E to the matrices A and B in equation xₜ₊₁=Axₜ+Buₜ.

In certain embodiments, the matrix A is defined by:

$$A = [ \begin{matrix}0 & 1 & 0 & 0 \\ 0 & - \frac{{C}_{f} + {C}_{r}}{mV} & \frac{{C}_{f} + {C}_{r}}{m} & \frac{{l}_{r} {C}_{r} - {l}_{f} {C}_{f}}{mV} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] ,$$

the matrix B is defined by:

$$B = [ \begin{matrix}0 \\ \frac{{C}_{f}}{m} \\ 0 \\ \frac{{l}_{f} {C}_{f}}{{l}_{z}}\end{matrix} ] ,$$

m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and the center of vehicle, and l_{z} is moment of inertia.

In certain embodiments, the state parameters of the autonomous vehicle include lateral position error, lateral position error rate, yaw angle error, and yaw angle error rate.

In certain embodiments, the control input of the autonomous vehicle include torque applied to wheels of the autonomous vehicle to accelerate or brake the autonomous vehicle, and yaw moment applied to steering wheel of the autonomous vehicle to adjust yaw angle.

In certain embodiments, the controller is further configured to provide a planned path for the autonomous vehicle.

In certain embodiments, the vehicle sensors comprise at least one of a camera, a LIDAR device, and a global positioning system (GPS).

In certain embodiments, the vehicle sensors include at least one of a speedometer, an accelerometer, and an inertial measurement unit (IMU).

In certain embodiments, the controller is an embedded device.

In certain aspects, the present disclosure relates to a method for controlling an autonomous vehicle. In certain embodiments, the method includes: receiving, by a controller of the autonomous vehicle, state parameters from vehicle sensors installed on the autonomous vehicle; quantifying, by the controller, a dynamics error bound based on the state parameters using linear least square; determining, by the controller, state space model of the autonomous vehicle by incorporating the dynamics error bound in the state space model; minimizing, by the controller, cost function of a linear quadratic regulator based on the state space model to obtain control input; and controlling, by the controller, the autonomous vehicle using the obtained control input.

In certain embodiments, the state space model is defined by xₜ₊₁=Axₜ+Buₜ+ωₜ. xₜ₊₁ is state of the vehicle at time t+1, xₜ is state of the vehicle at time t, uₜ is the control input of the vehicle at time t, and A and B are matrices of the state space model. Let xₜ₊₁=Θzₜ+ωₜ, Θ=[A B],

$${z}_{t} = [ \begin{matrix}{x}_{t} \\ {u}_{t}\end{matrix} ] ,$$

and for n sampling data, the disclosure has X=ΘZ+W,

$$X = [ \begin{matrix}{x}_{1} \\ {x}_{2} \\ ⋮ \\ {x}_{t + 1} \\ ⋮ \\ {x}_{n}\end{matrix} ] , Z = [ \begin{matrix}{z}_{0} \\ {z}_{1} \\ ⋮ \\ {z}_{t} \\ ⋮ \\ {z}_{n - 1}\end{matrix} ] , W = [ \begin{matrix}{ω}_{0} \\ {ω}_{1} \\ ⋮ \\ {ω}_{t} \\ ⋮ \\ {ω}_{n - 1}\end{matrix} ] .$$

The dynamics error bound is calculated by E=(Z^{T}Z)⁻¹ZW, and the state space model is obtained by adding the dynamics error bound E to the matrices A and B in equation xₜ₊₁=Axₜ+Buₜ.

In certain embodiments, the matrix A is defined by:

$$A = [ \begin{matrix}0 & 1 & 0 & 0 \\ 0 & - \frac{{C}_{f} + {C}_{r}}{mV} & \frac{{C}_{f} + {C}_{r}}{m} & \frac{{l}_{r} {C}_{r} - {l}_{f} {C}_{f}}{mV} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] ,$$

the matrix B is defined by:

$$B = [ \begin{matrix}0 \\ \frac{{C}_{f}}{m} \\ 0 \\ \frac{{l}_{f} {C}_{f}}{{l}_{z}}\end{matrix} ] ,$$

m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and the center of vehicle, and l_{z} is moment of inertia.

In certain aspects, the present disclosure relates to a non-transitory computer readable medium storing computer executable code. In certain embodiments, the computer executable code, when executed at a processor of a robotic device, is configured to perform the method described above.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 schematically depicts a system for controlling an autonomous driving vehicle according to certain embodiments of the present disclosure.

FIG. 2 schematically depicts a method for controlling an autonomous driving vehicle according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In certain aspects, the present disclosure optimizes the linear quadratic regulator (LQR) control law by using the quantification of the system uncertainty. The optimization makes the practical implementation of the LQR control simple yet novel, and with high efficiency. In certain embodiments, by providing a simple method to quantify the system uncertainty and error for a nominal system dynamics, the controller can minimize the worst case performance of the system with uncertainty upper bound.

The present disclosure is an improvement for vehicle dynamic modelling and LQR control. In certain embodiments, for the lane keeping objective of autonomous driving, it is useful to model a dynamic model in terms of position and orientation error with respect to the road. Based on lateral vehicle dynamics derivation, the state space model can be written as:

$$\frac{d}{dr} [ \begin{matrix}{e}_{y} \\ {\dot{e}}_{y} \\ {e}_{θ} \\ {\dot{e}}_{θ}\end{matrix} ] = A [ \begin{matrix}{e}_{y} \\ {\dot{e}}_{y} \\ {e}_{θ} \\ {\dot{e}}_{θ}\end{matrix} ] + B δ , \qquad ( 1 )$$

where e_{y} is lateral position error, ė_{y} is lateral position error rate, e_{θ} is yaw angle error, ė_{θ} is yaw angle error rate, δ is the energy input that may include torque for controlling acceleration/braking and momentum for controlling steering angle, A and B are matrices, and the A and B matrices are system dynamics model. In certain embodiments, the system dynamics model can be defined by:

$$\begin{matrix}A = [ \begin{matrix}0 & 1 & 0 & 0 \\ 0 & - \frac{{C}_{f} + {C}_{r}}{mV} & \frac{{C}_{f} + {C}_{r}}{m} & \frac{{l}_{r} {C}_{r} - {l}_{f} {C}_{f}}{mV} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] , and & ( 2 ) \\ B = [ \begin{matrix}0 \\ \frac{{c}_{f}}{m} \\ 0 \\ \frac{{l}_{f} {C}_{f}}{{l}_{z}}\end{matrix} ] , & ( 3 )\end{matrix}$$

where m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and center of vehicle, l_{z} is moment of inertia.

In certain embodiments, based on the above vehicle lateral dynamics modelling, an optimal control method such as LQR can be applied. For the above lateral vehicle dynamics model, the objective is to design an LQR state feedback controller to keep lane precisely. The controller can be obtained from the solution of an optimal control problem to minimize the cost function J as follows:

J=Σₜ₌₀^{N-1}xₜ^{T}Qxₜ+uₜ^{T}Ruₜ (4).

The cost function is minimized by weighting Q of controlled states and weighting R of control input, and tracking error and/or steering angle value are minimized. In certain embodiments, Q and R are user defined positive semidefinite and the positive definite matrices, which can be used to adjust the weightings of the tracking error and control input. t is the sampling of the time, and t from 0 to N−1 is a discrete representation of a period of time for sampling. For example, the total sampling time period S is divided equally into N time frames corresponding to a sampling frequency, time point t=0 is the beginning of the time period S, and time point t=N−1 is the end of the time period S. When the time period S is 5 second, sampling frequency is 10 Hz, which means a sampling in every 0.1 second, then each time frame between two adjacent time points are 0.1 second, and N would be 50. xₜ is the state of the vehicle at the time point t, and xₜ^{T} is the transpose of xₜ. uₜ is the control input of the vehicle at the time point t, and uₜ^{T} is the transpose of uₜ. Here uₜ could be a vector or a scalar. When uₜ is a scalar, the uₜ^{T}Ruₜ can also be written as R(uₜ)².

In certain embodiments, the state feedback control law is in the form of uₜ=−Kxₜ. The state feedback control coefficients K can be solved from the discrete algebraic Riccati equation:

A^{T}P+PA+Q−PBR⁻¹B^{T}P=0 (5).

K=R⁻¹B^{T}P (6).

By calculating P using the equation (5) and then calculating K using the equation (6), the minimized cost function can be obtained.

In order to obtain perfect state feedback K from the formula above, the system dynamics must be accurate. When the dynamics matrices A and B has large uncertainty induced by noise or estimation error, the control performance will be reduced dramatically.

In certain embodiments, there are two kind of solutions to address the problem in the autonomous driving LQR control when the system dynamics estimation is inaccurate. One is to collect some data to fit a model, and then solve the LQR problem assuming this estimated model is accurate; the other is to model the dynamics from Newton's law as discussed above, and then solve the LQR assuming the dynamics modelling is accurate. Unfortunately, for the first approach, it is difficult to determine how many data is sufficient in practice, and for the second approach, the steering stiffness is hard to model accurately.

In certain aspects, the present disclosure develops a new approach combining the above two methods together. In certain embodiments, the present disclosure considers the dynamic model of equations (1)-(3) as the nominal system, where the nominal system means that the dynamics of the system is roughly correct without any noise disturbance. On the other hand, the disclosure estimates the system dynamics error bound by the simple yet novel method of linear least squares. In certain embodiments, by running experiments, the disclosure excites the vehicle with Gaussian noise for some time, records the state observations, and finally estimates the dynamics error bound. By adding this dynamics error bound on to the nominal vehicle dynamics, the LQR performance is improved greatly.

In certain embodiments, the least squares estimation is as follows. The disclosure first defines the discrete vehicle system state space as:

xₜ₊₁=Axₜ+Buₜ+ωₜ (7),

where xₜ₊₁ and xₜ are respectively states of the vehicle at time t+1 and time t, uₜ is the control input of the vehicle at time t, ωₜ is the noise to the system at time t, and A and B are matrices of the system dynamics model.

Let Θ=[A B] and

$${z}_{t} = [ \begin{matrix}{x}_{t} \\ {u}_{t}\end{matrix} ] ,$$

then the system dynamics can be rewritten as:

xₜ₊₁=Θzₜ+ωₜ (8).

For n sampling data, the formula (8) can be defined by:

$$X = [ \begin{matrix}{x}_{1} \\ {x}_{2} \\ ⋮ \\ {x}_{n}\end{matrix} ] , Z = [ \begin{matrix}{z}_{0} \\ {z}_{1} \\ ⋮ \\ {z}_{n - 1}\end{matrix} ] , W = [ \begin{matrix}{ω}_{0} \\ {ω}_{1} \\ ⋮ \\ {ω}_{n - 1}\end{matrix} ] \\ X = θ Z + W . \qquad ( 9 )$$

In general, to solve this overdetermined linear equations, one approach to approximately solve it is to obtain the optimal solution Θ by minimizing ∥ΘZ+W−X∥₂. By using pseudo-inverse, we can get:

\hat{Θ}=(Z^{T}Z)⁻¹ZX+(Z^{T}Z)⁻¹ZW (10),

where \hat{Θ} is the predicted value of Θ, Z^{T} is the transpose of Z, and W is a noise, such as a Gaussian noise with zero-mean and covariance σ_{ω}. Accordingly, the estimation error E is written by:

E=\hat{Θ}−Θ=[Â−A \hat{B}−B]=(Z^{T}Z)⁻¹ZW (11),

where Â and \hat{B} are respectively prediction value of matrices A and B.

By adding the estimation error E in equation (11) to the state space model of equation (1), the vehicle system state defined by equation (7) is obtained.

In certain embodiments, since the last mile delivery vehicle's operation speed is generally below 5 meters/second (m/s), we can consider the system is a time invariant system, and the steering stiffness is identical during operations. Therefore, this estimation of dynamics error can be utilized.

In applications, a sine wave with various frequencies can be generated and applied into the steering angle. Observation noise with different variance can be applied into the localization, then record observation data. The errors are estimated by least squares. Thus, the supremum of the estimation errors by multiple rounds can be defined as:

$${E}_{sup} {sup}_{r ∈ N} \{ {‖ {E}_{r} ‖}_{2} \} ) , \qquad ( 12 )$$

where Eₛᵤₚ is the supremum of the error, and Eᵣ is the r-th round of error estimation. In certain embodiments, we can measure multiple times to find the worse case. In the above embodiments, the largest estimation error from several round of disturbance is selected as the estimation error. In certain embodiments, each of the several round of disturbance has an estimation error, and the average of the estimation errors selected as the estimation error. The average estimation error is then added to the A and B matrix in the equation (1) to obtain accurate state estimation.

Based on the supremum of the estimation error, the LQR controller can be designed optimally as this worse-case error.

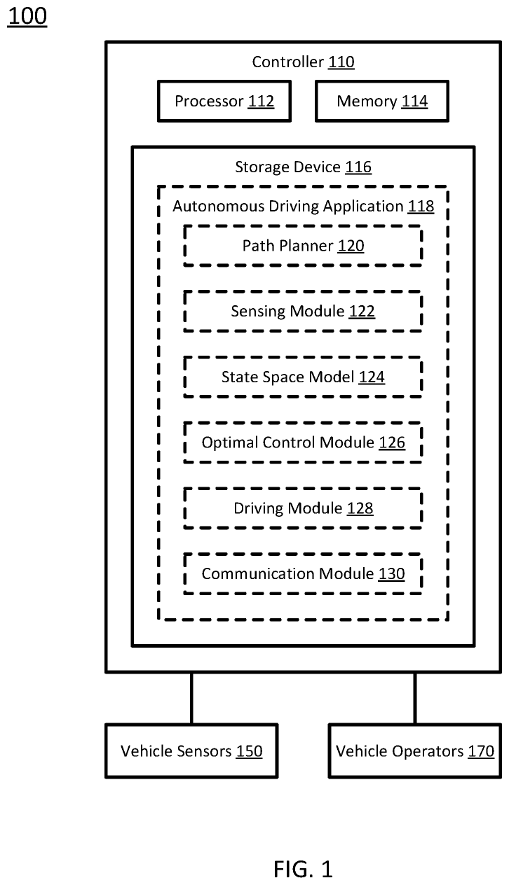

FIG. 1 schematically depicts a vehicle control system according to certain embodiments of the present disclosure. In certain embodiments, the vehicle is an autonomous vehicle or a self-driving vehicle. The autonomous vehicle could be an electric vehicle, a gasoline vehicle, a diesel vehicle, a hybrid vehicle, or a vehicle using other energy sources. As shown in FIG. 1, the system 100 includes a controller 110, vehicle sensors 150, and vehicle operators 170. In certain embodiments, the controller 110 shown in FIG. 1 may be a server computer, a cluster, a cloud computer, a general-purpose computer, a headless computer, or a specialized computer, which provides self-driving service. In certain embodiments, the controller 110 is a specialized computer or an embedded system which have limited computing power and resources. The controller 110 may include, without being limited to, a processor 112, a memory 114, and a storage device 116. In certain embodiments, the controller 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The vehicle sensors 150 are configured to collect parameters of the vehicle so as to determine the state of the vehicle. In certain embodiments, the vehicle sensors 150 is configured to collect the parameters according to an instruction from the controller 110 and send the collected parameters to the controller 110. In certain embodiments, the vehicle sensors 150 may not need instruction from the controller 110, and the vehicle sensors 150 are configured to collect the parameters when the autonomous vehicle is running, and send the collected parameters to the controller 110. In certain embodiments, the vehicle sensors 150 are configured to collect the parameters at real time. The vehicle sensors 150 may include, but are not limited to, one or more of an image sensor such as a red green and blue (RGB) camera, a gray scale camera or an RGB-depth (RGB-D) camera, a light detection and ranging (LIDAR) sensor, a Radar sensor, a global positioning system (GPS), a speedometer, an accelerometer, and an inertial measurement unit (IMU).

The vehicle operators 170 are configured to operate the autonomous vehicle according to instructions from the controller 110. In certain embodiments, the operation is performed by controlling torque applied to wheels to increase or decrease speed of the vehicle, and controlling a yaw moment to change steering angle.

The processor 112 may be a central processing unit (CPU) which is configured to control operation of the controller 110. In certain embodiments, the processor 112 can execute an operating system (OS) or other applications of the controller 110. In certain embodiments, the controller 110 may have more than one CPU as the processor, such as two CPUs, four CPUs, eight CPUs, or any suitable number of CPUs. The memory 114 may be a volatile memory, such as the random-access memory (RAM), for storing the data and information during the operation of the controller 110. In certain embodiments, the memory 114 may be a volatile memory array. In certain embodiments, the robotic device 110 may run on more than one processor 112 and/or more than one memory 114. The storage device 116 is a non-volatile data storage media or device. Examples of the storage device 116 may include flash memory, memory cards, USB drives, solid state drives, or other types of non-volatile storage devices such as hard drives, floppy disks, optical drives, or any other types of data storage devices. In certain embodiments, the controller 110 may have more than one storage device 116. In certain embodiments, the controller 110 may also include a remote storage device 116.

The storage device 116 stores computer executable code. The computer executable code includes an autonomous driving application 118. The autonomous driving application 118 includes the code or instructions which, when executed at the processor 112, may perform autonomous driving following a planned path. In certain embodiments, the autonomous driving application 118 may not be executable code, but in a form of circuit corresponding to the function of the executable code. By providing a circuit instead of executable code, the operation speed of the autonomous driving application 118 is greatly improved. In certain embodiments, as shown in FIG. 1, the autonomous driving application 118 includes, among other things, a path planner 120, a sensing module 122, a state space model 124, an optimal control model 126, a driving module 128, and a communication module 130.

The path planner 120 is configured to provide a planned path from a start point to a target point, initialize a driving project based on the planned path, provide behavior and motion guidance for the vehicle under real-time driving environment, and instruct the sensing module 122 to collect information of the environment during the driving along the planned path. In certain embodiments, the path is provided considering safety, convenience, and economical benefit of the route.

The sensing module 122 is configured to, during driving of the autonomous vehicle, receive or collect sensing information from the vehicle sensors 150 and feedback information from the vehicle operators 170, process the sensing information and the feedback information to obtain state parameters, and send the state parameters to the state space model 124. The state parameters may include, for example, lateral position error, lateral position error rate, yaw angle error, yaw angle error rate, steering angle, control input applied to accelerate or brake wheels, control input applied to change steer angle. In certain embodiments, the vehicle sensors 150 include multiple cameras, and the sensing module 122 is configured to process the images collected by the cameras to determine the real-time position and orientation of the vehicle and compare the position and orientation with the planned path. In certain embodiments, the sensing module 122 may include a neural network to process the images. In certain embodiments, the vehicle sensors 150 include a LIDAR, and the sensing module 122 is configured to process scanning images collected by the LIDAR to determine objects around the vehicle. In certain embodiments, the vehicle sensors 150 include a speedometer, and the sensing module 122 is configured to receive the real-time speed of the vehicle. In certain embodiments, the vehicle sensors 150 include an IMU, and the sensing module 122 is configured to receive the real-time force, angular rate, and orientation of the vehicle. In certain embodiments, the sensing module 122 is configured to receive controlling torque and yaw moment from the vehicle operator 170.

The state space model 124 is configured to, upon receiving the state parameters from the sensing module 122, estimate dynamics error bound of the autonomous vehicle at real-time, determining state space of the autonomous vehicle by adding the dynamics error bound to model matrices of a nominal dynamics system, and send the state space of the autonomous vehicle to the optimal control module 126. In certain embodiments, the state space model 124 is configured to use the equations (7)-(11) to estimate the dynamics error bound of the state space of the autonomous vehicle, and add the dynamics error bound to the matrices A and B in the equation (1) to obtain the state space of the autonomous vehicle.

The optimal control module 126 is configured to, upon receiving the state space of the vehicle from the state space model 124, solve an optimal control problem according to the state space to obtain control input, and send the control input energy to the driving module 128. In certain embodiments, the optimal control module 126 is an LQR controller, and the optimization is performed by minimizing the cost function of the equation (4). In certain embodiments, the control input includes input to accelerate or brake the autonomous vehicle, and input to change steer angle of the autonomous vehicle.

The driving module 128 is configured to, upon receiving the control input from the optimal control module 126, drive the autonomous vehicle using the control input, via the vehicle operators 170. The control input may include both the torque applied to the wheels to accelerate or brake the vehicle, and the yaw moment applied to the steering wheel to adjust yaw angle. In certain embodiments, the application of the torque and the moment include the magnitude to be applied and the time needed for the application.

In certain embodiments, the autonomous driving application 118 may further include the communication module 130, and the communication module 130 is configured to provide display of the information related to at least one of the path planner 120, the sensing module 122, the state space model 124, the optimal control module 126, the driving module 128, and is configured to provide an interface for interacting with a driver that drives the vehicle or an engineer that maintains the vehicle.

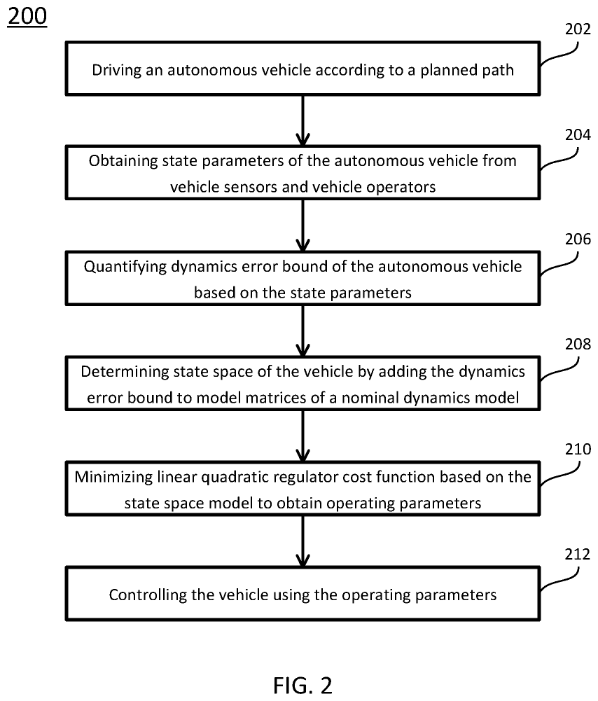

FIG. 2 schematically depicts a method for controlling an autonomous vehicle according to certain embodiments of the present disclosure. In certain embodiments, the method 200 as shown in FIG. 2 may be implemented on a controller 110 as shown in FIG. 1. It should be particularly noted that, unless otherwise stated in the present disclosure, the steps of the method may be arranged in a different sequential order, and are thus not limited to the sequential order as shown in FIG. 2.

At procedure 202, the path planner 120 provides a planned path for an autonomous vehicle, such that the autonomous vehicle begins a driving project from a starting point to a target point of the planned path.

At procedure 204, during the driving of the autonomous vehicle, the sensing module 122 receives or collects sensing information from the vehicle sensors 150 and feedback information from the vehicle operators 170, processes the sensing information and feedback information to obtain state parameters of the autonomous vehicle, and sends the state parameters to the state space model 124.

At procedure 206, upon receiving the state parameters from the sensing module 122, the state space model 124 quantifies dynamics error bound of the autonomous vehicle based on the received state parameters. The parameters received from the sensing module 122 may include lateral position error, lateral position error rate, yaw angle error, yaw angle error rate, and steering angle. In certain embodiments, the state space model 124 uses the equations (7)-(11) to estimate the dynamics error bound of the autonomous vehicle.

At procedure 208, after obtaining the dynamics error bound, the state space model 124 adds the dynamics error bound to the matrices A and B of the equation (1) to obtain the state space of the autonomous vehicle, and sends the state space of the vehicle to the optimal control module 126.

At procedure 210, upon receiving the state space of the vehicle from the state space model 124, the optimal control module 126 solves an optimal control problem according to the state space to obtain control input, and sends the control input to the driving module 128. In certain embodiments, the optimal control module 126 is an LQR controller, and the optimization is performed by minimizing the cost function of the equation (4).

At procedure 212, upon receiving the control input from the optimal control module 126, the driving module 128 drives the vehicle based on the control input through the vehicle operators 170. The control input may include both the torque applied to the wheels to accelerate or brake the vehicle, and the yaw moment applied to the steering wheel to adjust yaw angle. In certain embodiments, the application of the torque and the moment include the magnitude to be applied and the time needed for the application.

In certain embodiments, the method 200 may further include a procedure of providing display of information related to the autonomous vehicle and providing interface for interactions between a driver or a maintenance engineer and the autonomous vehicle.

In certain embodiments, the system and method described above is suitable for implementing last mile autonomous delivery vehicle, but are not limited to the last mile autonomous delivery vehicle. For example, the system and method may also be used on autonomous robots, autonomous passenger cars, and autonomous buses.

In a further aspect, the present disclosure is related to a non-transitory computer readable medium storing computer executable code. The code, when executed at a processer 112 of the controller 110, may perform the methods 200 as described above. In certain embodiments, the non-transitory computer readable medium may include, but not limited to, any physical or virtual storage media. In certain embodiments, the non-transitory computer readable medium may be implemented as the storage device 116 of the controller 110 as shown in FIG. 1.

In summary, certain embodiments of the present disclosure quantifies system dynamic error using liner least square, and estimates the state space model accurately and efficiently by incorporating the system dynamic error. With the accurate and efficient estimation of the state space of the vehicle, LQR optimization can be achieved with great success.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A system for controlling an autonomous vehicle, comprising vehicle sensors and a controller installed on the autonomous vehicle, wherein the controller comprises a processor and a storage device storing computer executable code, and the computer executable code, when executed at the processor, is configured to:
receive state parameters of the autonomous vehicle from the vehicle sensors;
quantify a dynamics error bound based on the state parameters using linear least square;
determine a state space model of the autonomous vehicle by incorporating the dynamics error bound in the state space model;
minimize cost function of a linear quadratic regulator based on the state space model to obtain control input; and
control the autonomous vehicle using the control input.

2. The system of claim 1, wherein
the state space model is defined by xₜ₊₁=Axₜ+Buₜ+ωₜ, xₜ₊₁ is state of the autonomous driving vehicle at time t+1, xₜ is state of the autonomous driving vehicle at time t, uₜ is the control input of the autonomous driving vehicle at time t, and A and B are matrices of the state space model;
xₜ₊₁=Θzₜ+ωₜ, Θ=[A B],
$${z}_{t} = [ \begin{matrix}{x}_{t} \\ {u}_{t}\end{matrix} ] ,$$
and for n sampling data X=ΘZ+W,
$$X = [ \begin{matrix}{x}_{1} \\ {x}_{2} \\ ⋮ \\ {x}_{t + 1} \\ ⋮ \\ {x}_{n}\end{matrix} ] , Z = [ \begin{matrix}{z}_{0} \\ {z}_{1} \\ ⋮ \\ {z}_{t} \\ ⋮ \\ {z}_{n - 1}\end{matrix} ] , W = [ \begin{matrix}{ω}_{0} \\ {ω}_{1} \\ ⋮ \\ {ω}_{t} \\ ⋮ \\ {ω}_{n - 1}\end{matrix} ] ,$$
and the dynamics error bound is calculated by E=(Z^{T}Z)⁻¹ZW; and
the state space model is obtained by adding the dynamics error bound E to the matrices A and B in equation xₜ₊₁=Axₜ+Buₜ.

3. The system of claim 2, wherein
the matrix A is defined by:
$$A = [ \begin{matrix}0 & 1 & 0 & 0 \\ 0 & - \frac{{C}_{f} + {C}_{r}}{m V} & \frac{{C}_{f} + {C}_{r}}{m} & \frac{{l}_{r} {C}_{r} - {l}_{f} {C}_{f}}{m V} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] ;$$
the matrix B is defined by:
$$B = [ \begin{matrix}0 \\ \frac{{C}_{f}}{m} \\ 0 \\ \frac{{l}_{f} {C}_{f}}{{l}_{z}}\end{matrix} ] ;$$
and
m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and the center of vehicle, and l_{z} is moment of inertia.

4. The system of claim 2, wherein the state parameters of the autonomous vehicle comprise lateral position error, lateral position error rate, yaw angle error, and yaw angle error rate.

5. The system of claim 2, wherein the control input of the autonomous vehicle comprise torque applied to wheels of the autonomous vehicle to accelerate or brake the autonomous vehicle, and yaw moment applied to steering wheel of the autonomous vehicle to adjust yaw angle.

6. The system of claim 1, wherein the controller is further configured to provide a planned path for the autonomous vehicle.

7. The system of claim 1, wherein the vehicle sensors comprise at least one of a camera, a LIDAR device, and a global positioning system (GPS).

8. The system of claim 1, wherein the vehicle sensors comprise at least one of a speedometer, an accelerometer, and an inertial measurement unit (IMU).

9. The system of claim 1, wherein the controller is an embedded device.

10. A method for controlling an autonomous vehicle, comprising:
receiving, by a controller of the autonomous vehicle, state parameters from vehicle sensors installed on the autonomous vehicle;
quantifying, by the controller, a dynamics error bound based on the state parameters using linear least square;
determining, by the controller, state space model of the autonomous vehicle by incorporating the dynamics error bound in the state space model;
minimizing, by the controller, cost function of a linear quadratic regulator based on the state space model to obtain control input; and
controlling, by the controller, the autonomous vehicle using the control input.

11. The method of claim 10, wherein
the state space model is defined by xₜ₊₁=Axₜ+Buₜ+ωₜ, xₜ₊₁ is state of the vehicle at time t+1, xₜ is state of the vehicle at time t, uₜ is the control input of the vehicle at time t, and A and B are matrices of the state space model;
xₜ₊₁=Θzₜ+ωₜ, Θ=[A B],
$${z}_{t} = [ \begin{matrix}{x}_{t} \\ {u}_{t}\end{matrix} ] ,$$
and for n sampling data X=ΘZ+W,
$$X = [ \begin{matrix}{x}_{1} \\ {x}_{2} \\ ⋮ \\ {x}_{t + 1} \\ ⋮ \\ {x}_{n}\end{matrix} ] , Z = [ \begin{matrix}{z}_{0} \\ {z}_{1} \\ ⋮ \\ {z}_{t} \\ ⋮ \\ {z}_{n - 1}\end{matrix} ] , W = [ \begin{matrix}{ω}_{0} \\ {ω}_{1} \\ ⋮ \\ {ω}_{t} \\ ⋮ \\ {ω}_{n - 1}\end{matrix} ] ,$$
and the dynamics error bound is calculated by E=(Z^{T}Z)⁻¹ZW; and
the state space model is obtained by adding the dynamics error bound E to the matrices A and B in equation xₜ₊₁=Axₜ+Buₜ.

12. The method of claim 11, wherein
the matrix A is defined by:
$$A = [ \begin{matrix}0 & 1 & 0 & 0 \\ 0 & - \frac{{C}_{f} + {C}_{r}}{m V} & \frac{{C}_{f} + {C}_{r}}{m} & \frac{{l}_{r} {C}_{r} - {l}_{f} {C}_{f}}{m V} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] ;$$
the matrix B is defined by:
$$B = [ \begin{matrix}0 \\ \frac{{C}_{f}}{m} \\ 0 \\ \frac{{l}_{f} {C}_{f}}{{l}_{z}}\end{matrix} ] ;$$
and
m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and the center of vehicle, and l_{z} is moment of inertia.

13. A non-transitory computer readable medium storing computer executable code, wherein the computer executable code, when executed at a processor of an autonomous vehicle, is configured to:
receive state parameters of the autonomous vehicle from vehicle sensors installed on the autonomous vehicle;
quantify a dynamics error bound based on the state parameters using linear least square;
determine a state space model of the autonomous vehicle by incorporating the dynamics error bound in the state space model;
minimize cost function of a linear quadratic regulator based on the state space model to obtain control input; and
control the autonomous vehicle using the control input.

14. The non-transitory computer readable medium of claim 13, wherein
the state space model is defined by xₜ₊₁=Axₜ+Buₜ+ωₜ, xₜ₊₁ is state of the vehicle at time t+1, xₜ is state of the vehicle at time t, uₜ is the control input of the vehicle at time t, and A and B are matrices of the state space model;
xₜ₊₁=Θzₜ+ωₜ, Θ=[A B],
$${z}_{t} = [ \begin{matrix}{x}_{t} \\ {u}_{t}\end{matrix} ] ,$$
and for n sampling data X=ΘZ+W,
$$X = [ \begin{matrix}{x}_{1} \\ {x}_{2} \\ ⋮ \\ {x}_{t + 1} \\ ⋮ \\ {x}_{n}\end{matrix} ] , Z = [ \begin{matrix}{z}_{0} \\ {z}_{1} \\ ⋮ \\ {z}_{t} \\ ⋮ \\ {z}_{n - 1}\end{matrix} ] , W = [ \begin{matrix}{ω}_{0} \\ {ω}_{1} \\ ⋮ \\ {ω}_{t} \\ ⋮ \\ {ω}_{n - 1}\end{matrix} ] ,$$
and the dynamics error bound is calculated by E=(Z^{T}Z)⁻¹ZW; and
the state space model is obtained by adding the dynamics error bound E to the matrices A and B in equation xₜ₊₁=Axₜ+Buₜ.

15. The non-transitory computer readable medium of claim 14, wherein
the matrix A is defined by:
$$A = [ \begin{matrix}0 & 1 & 0 & 0 \\ 0 & - \frac{{C}_{f} + {C}_{r}}{m V} & \frac{{C}_{f} + {C}_{r}}{m} & \frac{{l}_{r} {C}_{r} - {l}_{f} {C}_{f}}{m V} \\ 0 & 0 & 0 & 1 \\ 0 & \frac{{l}_{r} {C}_{r} - {l}_{f} {C}_{f}}{{I}_{z} V} & \frac{{l}_{f} {C}_{f} - {l}_{r} {C}_{r}}{{I}_{z}} & \frac{{l}_{r}^{2} {C}_{r} - {l}_{f}^{2} {C}_{f}}{{I}_{z} V}\end{matrix} ] ;$$
the matrix B is defined by:
$$B = [ \begin{matrix}0 \\ \frac{{C}_{f}}{m} \\ 0 \\ \frac{{l}_{f} {C}_{f}}{{l}_{z}}\end{matrix} ] ;$$
and
m is mass of the vehicle, C_{f} is front wheels' steering stiffness, Cᵣ is rear wheels' steering stiffness, V is longitudinal vehicle speed, l_{f} is distance between center of the front wheels and center of vehicle, lᵣ is distance between center of the rear wheels and the center of vehicle, l_{z} is moment of inertia.
